(19) United States
(12) Patent Application Publication
(10) Pub. No.: US 2018/0159839 A1
(43) Pub. Date: Jun. 7, 2018

(54) MOBILE CREDENTIAL REDEMPTION CARD

(71) Applicant: Nortek Security & Control LLC, Carlsbad, CA (US)

(72) Inventor: Steven Douglas Citron, Oceanside, CA (US)

(21) Appl. No.: 15/369,686

(22) Filed: Dec. 5, 2016

(51) Int. Cl. H04L 29/06

(52) U.S. Cl. CPC H04L 63/08; H04L 63/10

(57) ABSTRACT

Disclosed herein are systems and methods for redeeming credential credits. A portable token that contains at least two identifiers may be provided. The token may identify a preset quantity of electronic credential credits and at least one of the identifiers may be concealed from view. A third identifier may be received from a user of the portable token, the third identifier associated with a credential credit management account of the user. The user may be authenticated based on at least the third identifier. Upon successful authentication, the preset quantity of the electronic credential credits may be issued to the credential credit management account of the user. An electronic credential may be generated based on the issued credential credits for communication to a remote user. The electronic credential may authenticate the remote user with an access control system.

### TECHNICAL FIELD

Embodiments pertain to distribution, management, and issuance of electronic credentials, such as credentials for gaining authorization to an access control system (e.g., secure building access, secure terminal access, and so forth). Some embodiments relate to a mobile credential redemption card.

### BACKGROUND

With the increase in different types of devices communicating with various network devices and access control systems, usage of user authentication systems has become a necessity. For example, a company may need to provide secure building access to multiple employees, while preventing access by non-employees. The process to establish secure access to multiple employees, however, may be time consuming as a user profile with a unique electronic key (or a credential) may need to be generated for each employee.

### SUMMARY OF THE DISCLOSURE

Embodiments of the present disclosure can provide a system and method for multi-tier distribution of credits that can be redeemed via a portable token through a local or cloud-based credential distribution and management server, for electronic keys/credentials (or “virtual credentials”). The credentials can then be distributed to end-user's mobile devices (e.g., smart phones) allowing such devices to pass credential numbers to an access control and/or security system via a near field communication (NFC), Bluetooth, and/or WiFi-enabled credential reader. In an example, a portable token includes first and second identifiers, such as a visible serial number and a concealed control number that can be derived from the serial number. A credential management and issuance administrator, such as an installing security dealer, is identified by a third identifier. A local or cloud-based credential distribution and management server may generate a number of key/credential credits from the first, second and third identifiers, and may be operative to allow the credential management administrator to manage and distribute such keys to mobile devices (e.g., smart phones running Apple iOS or Android operating systems), as part of a local and/or cloud-based electronic credential management and issuance system.

Embodiments of the present disclosure can provide a method for automatically generating credentials. A portable token (e.g., a plastic card) may be provided which may contain at least two identifiers. The portable token may identify a preset quantity of electronic credential credits and at least one of the identifiers may be concealed from view (e.g., by a tamper revealing film). A third identifier may be received from a user of the portable token. The third identifier may be associated with a credential credit management account of the user. The user can be authenticated based on at least the third identifier. Upon successful authentication, the preset quantity of the electronic credential credits may be issued to the credential credit management account of the user. An electronic credential may be generated for communication to a remote user, based on the issued credential credits. The electronic credential may be used to authenticate the remote user with an access control system.

In an example, a portable token for obtaining a plurality of electronic credentials is provided. The token may include a first identifier that is visible on the token, and a second identifier that is concealed from view by a temporary cover on at least a portion of the token. The first identifier may allow for determining a quantity of the plurality of electronic credentials. Additionally, the first identifier and the control identifier allow a user to obtain access to the determined quantity of electronic credentials upon entering a third identifier, the third identifier associated with an account of the user.

In an example, a system may include a memory and a processor coupled to the memory. The processor may be configured to detect, using a portable token, a first identifier and a second identifier. The processor may further detect a third identifier of a user of the portable token, and derive a quantity of electronic credential credits using the first identifier. The processor may be further configured to authenticate the user based on the first, second and third identifiers. Upon successful authentication, the processor may be configured to issue the quantity of electronic credential credits to a credential credit management account of the user.

This overview is intended to provide an overview of subject matter of the present patent application. It is not intended to provide an exclusive or exhaustive explanation of the invention. The detailed description is included to provide further information about the present patent application,

### BRIEF DESCRIPTION OF THE FIGURES

In the figures, which are not necessarily drawn to scale, like numerals may describe similar components in different views. Like numerals having different letter suffixes may represent different instances of similar components. Some embodiments are illustrated by way of example, and not limitation, in the following figures of the accompanying drawings.

FIG. 1 is a diagram of a credential redemption card in accordance with some embodiments.

FIG. 2 is a block diagram of a credential redemption system using a credential server, in accordance with sonic embodiments.

FIG. 3 is a flow diagram illustrating example functionalities for authenticating a credential administrator and issuing credentials using a credential redemption card, in accordance with some embodiments.

FIG. 4A is a block diagram of an example credential server, which can be used in the credential redemption system of FIG. 2, in accordance with an example embodiment.

FIG. 4B-FIG. 4M illustrate various functionalities, which can be performed by the credential server of FIG. 4A, in accordance with some embodiments.

FIG. 5 is a flow diagram illustrating example functionalities for issuing credentials of a specified type using a credential redemption card, in accordance with some embodiments.

FIG. 6 is a flow diagram illustrating example functionalities for automatically issuing credentials to a remote user from a credential administrator account using a credential redemption card, in accordance with some embodiments.

FIG. 7 illustrates a block diagram of a communication device, in accordance with some embodiments.

### DETAILED DESCRIPTION

The following description and the drawings sufficiently illustrate specific embodiments to enable those skilled in the art to practice them. Given the benefit of the present disclosure, persons skilled in the relevant technologies will be able to engineer suitable variations to implement principles of the embodiments in other types of communication systems. Various diverse embodiments may incorporate structural, logical, electrical, process, and other differences. Portions and features of some embodiments may be included in, or substituted for, those of other embodiments. Embodiments set forth in the claims encompass all presently-known, and after-arising, equivalents of those claims.

The present disclosure relates to multi-tier distribution of electronic credentials through a portable token (e.g., a card) redemption system. By distributing credits for a quantity of credentials via a single portable token that is redeemed through a cloud-based credential distribution and management server for actual credentials, security credential distributors and security dealers can inventory and distribute multiple virtual credentials to multiple users, where the credential credits are contained within a single physical item (e.g., a token such as a plastic card). By using generic credential “credits” that can be later redeemed for a variety of different types of credential formats from a cloud-based credential distribution and management server, the number of physical, packaged products that must be kept on distribution shelves is reduced, thereby lowering the cost of field inventory, and providing an additional advantage by placing the variation of credential types and formats in the cloud versus physical inventory that is stored and maintained by security credential distributors. As additional benefit, by reducing the number of physical, packaged products that must be kept on distribution shelves, the overall shipping costs of electronic credentials both outbound from manufacturer to distributor and then from distributor to dealer is also reduced. Furthermore, shipping and handling costs from dealer to end-user may also be significantly reduced or eliminated altogether because the credential is distributed to the end user electronically.

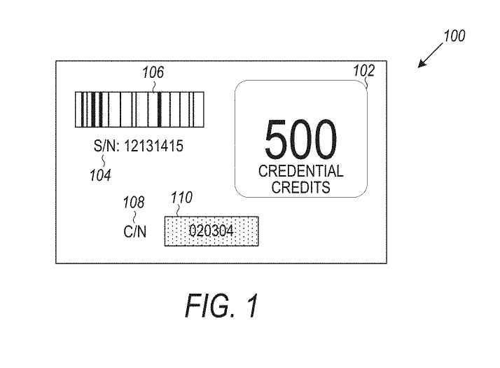

FIG. 1 is a diagram of a credential redemption card in accordance with some embodiments. Referring to FIG. 1, there is illustrated a portable token 100, which can be used for distribution and redemption of credential credits. The portable token 100 may be any of a variety of physical mediums, such as a plastic card, a USB drive, a CD, a DVD, and so forth. The token 100 may include a first identifier 104 and a second identifier 108, which can be used to redeem credential credits, as discussed herein. The token identifiers 104 and 108 can be two sets of alpha-numeric characters, but could take other forms as well, such as a QR-code, an MID tag, or other type of information medium that can be read/scanned by another device. The following disclosure is primarily of an embodiment, in which the portable token is a plastic card (e.g., as seen in FIG. 1), and the token identifiers take the form of a serial number 104 and a control number 108. However, the disclosure is not limited in this regard and a “token” and “token identifiers” can take other forms as well. For example, the first identifier 104 and the second identifier 108 may include numbers and/or characters.

In the example token 100 of FIG. 1, the serial number 104 is illustrated as the alpha-numeric sequence “12131415”, and the control number is illustrated as the alpha-numeric sequence “020304”. In an example, the serial number 104 may also be represented by a bar-code 106, a QR code, or another type of device-readable code or magnetic chip (not illustrated) In an example, the control number 108 may be concealed by, e.g., tamper-revealing coating/film 110. The coating 110 can be scratched-off to reveal the control number 108 Additionally, the token 100 may also include a quantity indicator 102 of the number of credential credits associated with the token (e.g., associated with the serial number 104 and/or the control number 108 of the token 100). In an example, the quantity of credential credits may also be referred to as a “value” of credits the token 100 is worth. For example, the token 100 can be referred to as having a value of 500 credits.

In an example, the serial number 104 can consist of 10 digits, represented by the following text string—AABBCCDDD. AA may be two digits (same or different) representing the type of card/token 100. The type can indicate the amount of credential credits—e.g., a 2-key card, a 25-key card, a 100-key card, etc. The type may also indicate the type of key/credential associated with the card. The digits BB and CC may indicate year and week date code (e.g., year and week the card was manufactured). The numbers DDDR (which may be the same or different numbers) may indicate a sequence number.

In an example, the serial number 104 (including the bar code 106) and the quantity indicator 102 may be visible through a card packaging, while the control number 108 can be covered by the card packaging. Displaying the serial number 104 and the bar code 106 can be used for card inventory management as well as to activate the card (and redeem the indicate quantity 102 of credential credits) at the point of sale.

In an example, in order to guard against fraudulent/unauthorized use or duplication of the token, the control number 108 can be derived using an algorithm that is indexed off of the serial number 104. Alternatively, a look-up table may be used to obtain the control number 108 corresponding to the serial number 104. In this regard, the authorized control number can be determined prior to removal of the coating 110 so that when the coating is removed and the exposed control number is entered, the entered number may be compared against the authorized control number that was determined using the serial number 104. The use of the two identifiers (serial number 104 and control number 108), where one identifier (e.g., control number 108) is related to, and can be derived from, the second identifier (e.g., serial number 104) provides a high level of security against unauthorized use, duplication, or counterfeiting of the portable token 100. In this regard, the control number 108 may also be referred to as a “validation number” as it is used to validate the authenticity of the token 100.

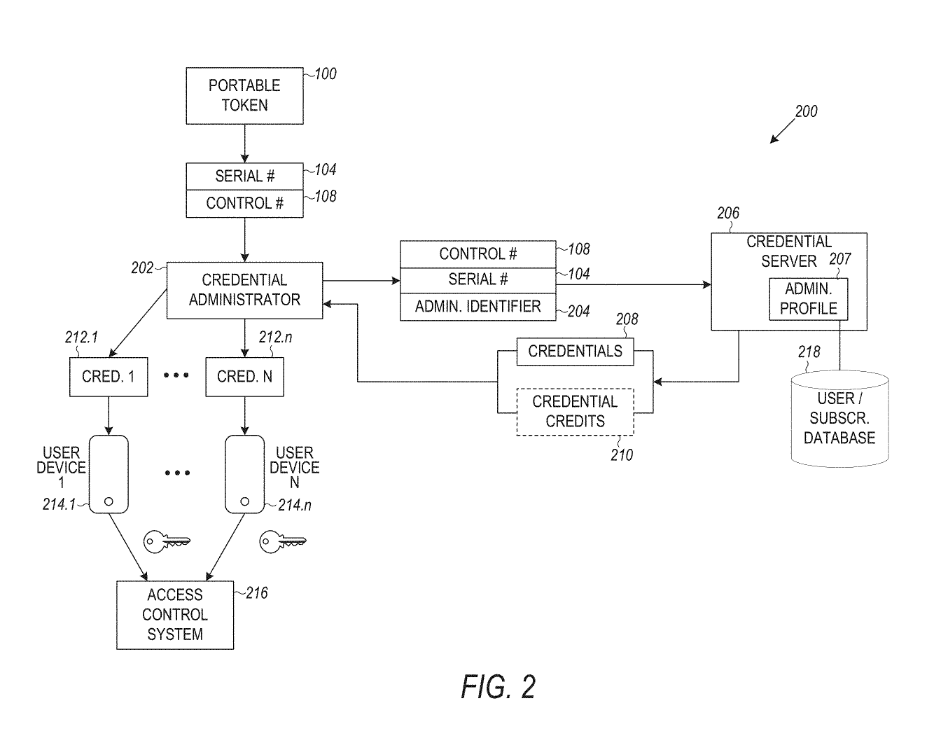

FIG. 2 is a block diagram of a credential redemption system using a credential server, in accordance with some embodiments. Referring to FIG. 2, the credential redemption system 200 can include a credential server 206 configured to communicate with a credential administrator (user) 202. The credential administrator 202 can be a secure credentials dealer/distributor, who can supply electronic credentials (e.g., secure keys) to a plurality of users (e.g., subscribers to secure access systems).

In an example, the credential administrator 202 may obtain a portable token (e.g., a card 100 as illustrated in FIG. 1) for a specified quantity of credential credits. The token 100 may be associated with at least two identifiers, such as a serial number 104 and a control number 108. The serial number 104 and the control number 108 may be provided to the credential server 206 along with a third identifier 204. The third identifier 204 may be an identifier representing the administrator 202 profile (or account) with the credential server 206. In an example, the identifier 204 may be a user name, an account number, a password or another identifier used by the administrator 202 to access the credential server 206 and/or a profile 207 of the administrator 202 maintained by the credential server 206.

In an example, the serial number 104 (or any combination of the identifiers 104, 108 and 204) may encode the quantity of credential credits (e.g., 102) associated with the token 100. The credential server 206 may authenticate the administrator 202 by generating a valid control number based on the entered serial number 104 (e.g., by using a look-up table or an algorithm that indexed off of the serial number), and matching the obtained valid control number with the entered control number 108. Further authentication of the administrator 202 may be based on the entered third (administrator) identifier 204. After the administrator 202 is successfully authenticated, the credential server may obtain the quantity of credential credits 210 associated with the token 100, using the serial number 104 (or any combination of the identifiers 104, 108 and 204). The determined quantity of credential credits 210 may then be issued to the administrator's profile 207 for subsequent use (e.g., in generating and distributing credentials to one or more users/subscribers to the credential provisioning services of the credential administrator 202).

In an example, the issued credential credits 210 can be used to generate a plurality of credentials 208. The credentials 208 can be secure electronic keys or other types of credentials, which can be used in connection with a mobile device to gain access to (or otherwise become an authorized user of) a remote control system (e.g., 216). The electronic credentials 208 can be of different types, such as of different encryption level or a different S credential duration. For example, an electronic credential type can include a 26-bit (e.g., Wiegand-compliant) credential, a 128-bit credential, a 256-bit credential, and so forth. An electronic credential type can also include a temporary credential (e.g., for a specified time duration), a one-time credential, or a permanent credential. Other types of credentials may be used as well in different embodiments. For example, a credential type may be associated with the credential encryption level. Additionally, a credential type may indicate a temporary credential with a predetermined expiration date, a schedule-associated credential only accessible at specific times, days and dates, a “one-time use” credential that expires after use, a permanent credential that can be replaced for no charge with every new phone the end-user purchases, and/or a standard credential that expires when the end-user changes mobile devices, requiring re-purchase of a credential.

Additionally, different number of credential credits may be used to generate a single credential of a specified type. For example, a one-time use credential may be generated using one-quarter of a single credit, while a permanent credential may be generated using a full credit (or maybe 1.5 credits).

In an example, the electronic credential type may also be detected using one or more of the identifiers (e.g., 104, 108 and/or 204) communicated to the credential server 206. For example, the credential type may be obtained using the serial number 104.

After obtaining the credential credit type, the credential credits may be automatically converted to a number of credentials 208, taking into account the determined credential type. In instances when the credential credit type is not specified by any of the identifiers (e.g., 104, 108) associated with the token 100, the credential server 206 may use credential credit type preference information, which may be specified in the administrator profile 207. For example, the profile 207 may indicate a preference of x number of permanent credentials to be issued first, followed by ay number of temporary credentials to be issued next, and so forth. In an example, the credential credits associated with a token may be redeemed and held as generic credential credits in an account (e.g., of an administrator) until converted to credentials of a specific credential type for issuance to an end user.

The profile 207 may further use a database 218, which may specify one or more subscribers to credential provisioning services provided by the administrator 202. For example, the subscriber database 218 may identify a subscriber (e.g., using a telephone number or an email address) as well as a credential preference for that subscriber. In this regard, after the credential credits 210 are issued to the account/profile (e.g., 207) of the administrator 202, the subscriber database can be accessed and a credential of the proper type can be issued for one or more of the subscribers specified within the database 218. In some examples, only certain subscribers may obtain credentials (e.g., subscribers with expired or missing/unissued credentials), while in other examples all subscribers may be issued credentials according to a specified credential type. In yet other examples, the credentials 208 may be issued to the account/profile 207 of the administrator 202, and the administrator 202 may manually issue (and communicate) credentials to one or more of the administrator's subscribers (e.g., credentials can be communicated directly to a user/subscriber device, such as a mobile phone).

In an example, after the credential credits 210 are issued to the administrator's profile 207, credentials 212.1, . . . , 212.n may be generated for corresponding n number of users (e.g., subscribers to the credential provisioning services provided by the administrator), each user being associated with a mobile device (e.g., collectively indicated in FIG. 2 as mobile devices 214.1, . . . , 214.n). The credentials for each user may then be communicated to the corresponding mobile devices 214.1, . . . , 214.n, and may be used by the devices 214.1, . . . , 214.n to obtain authorization with the access control system 216. In this regard, the credentials for each user are transferred to that user's device so that the credentials are resident on the device and can be used with the access control system regardless of connectivity between the devices 214 and the credential server 206.

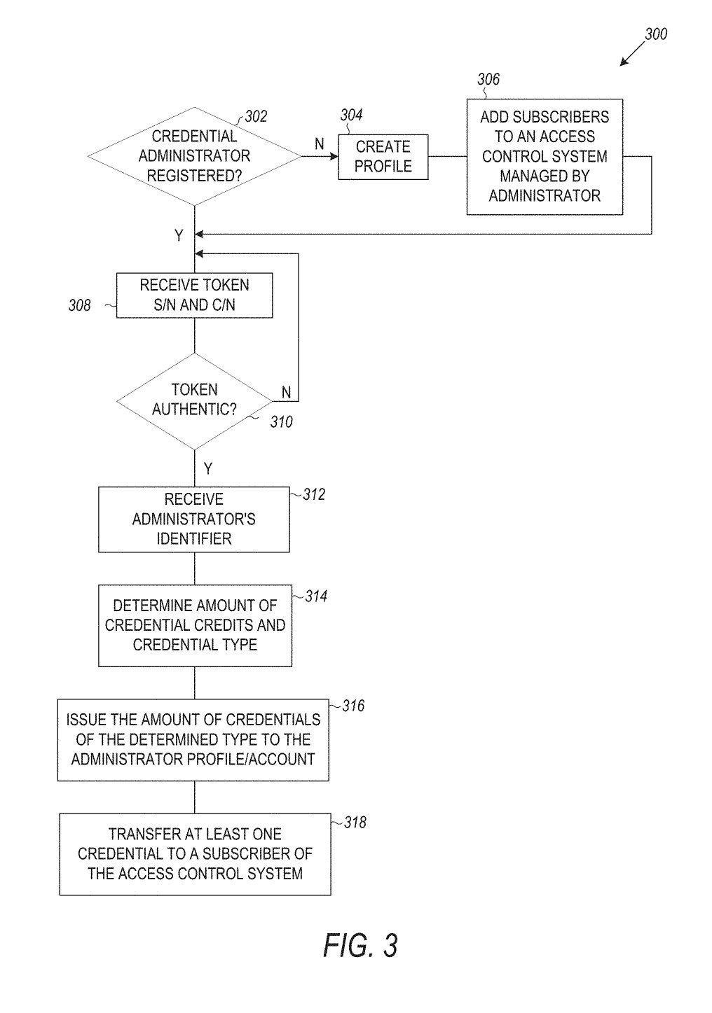

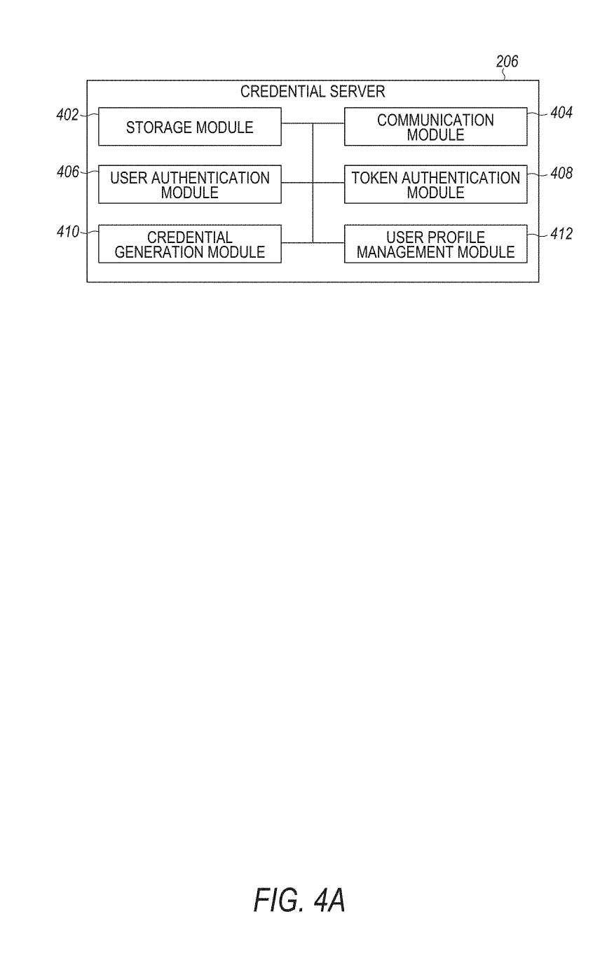

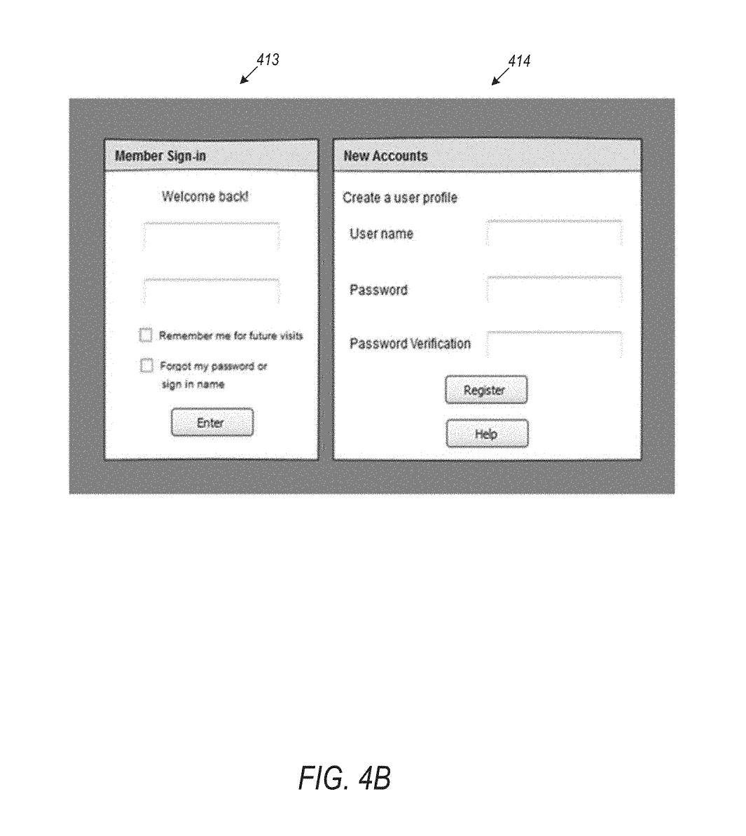

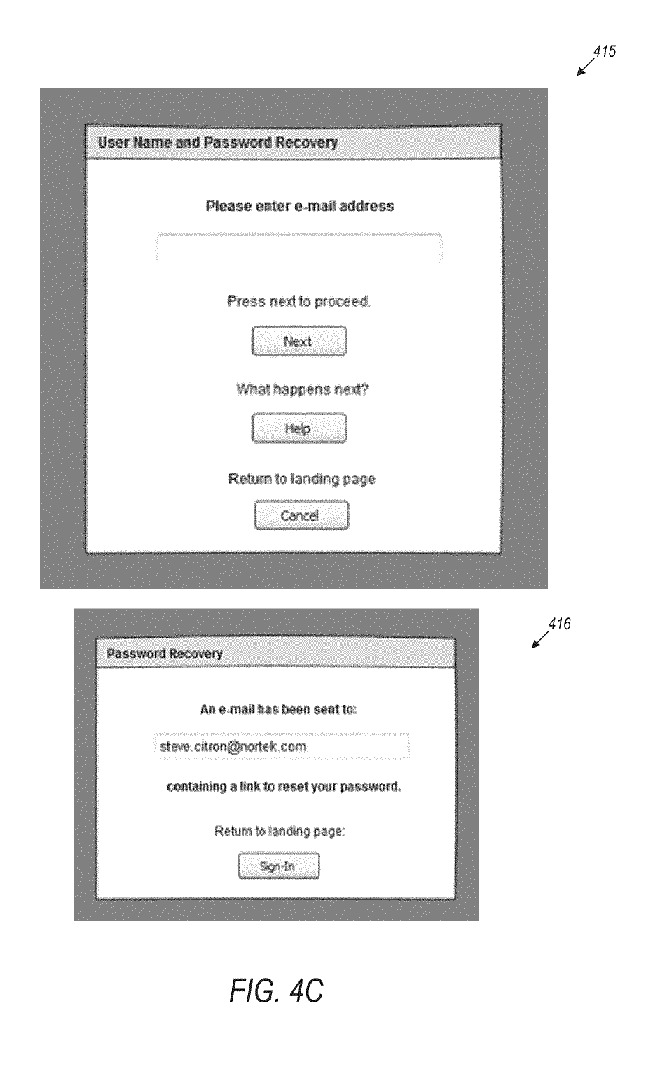

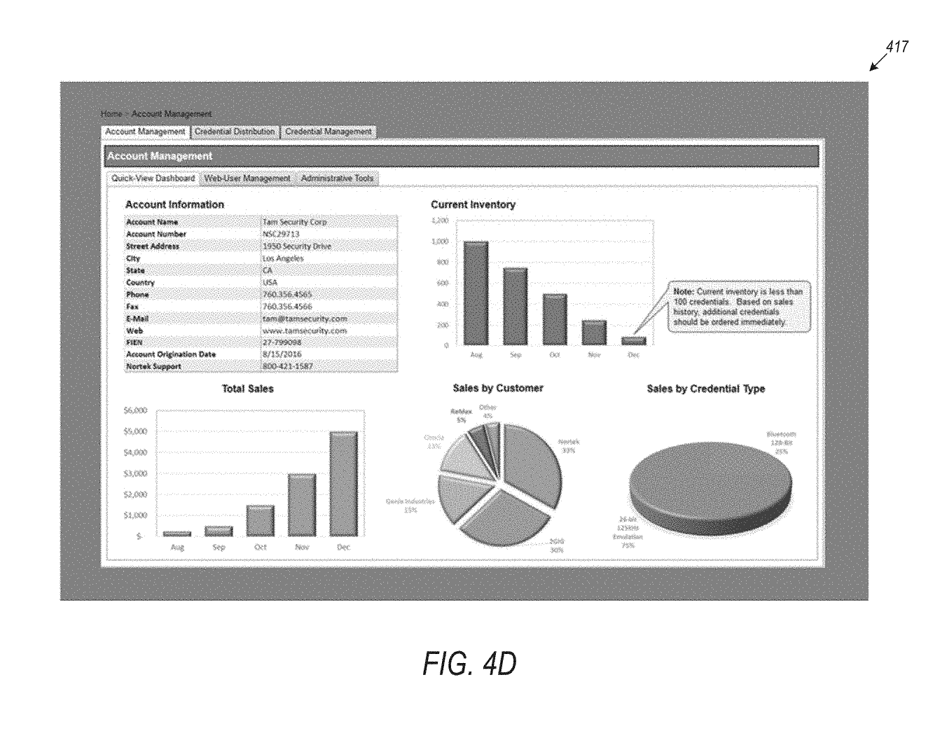

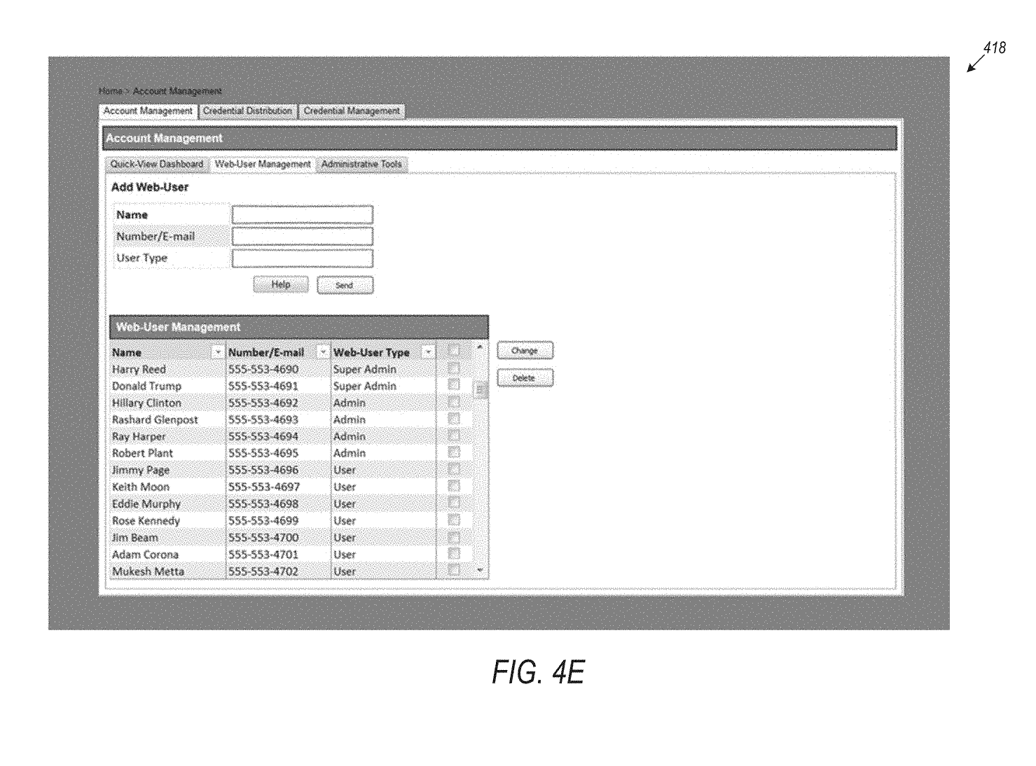

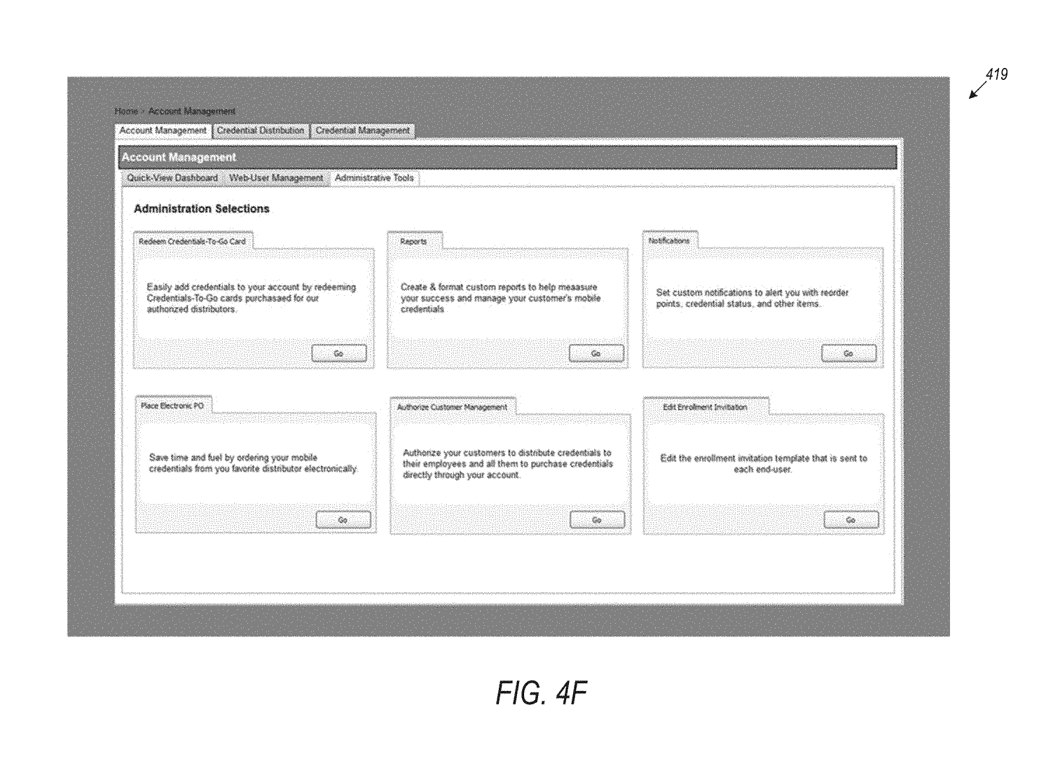

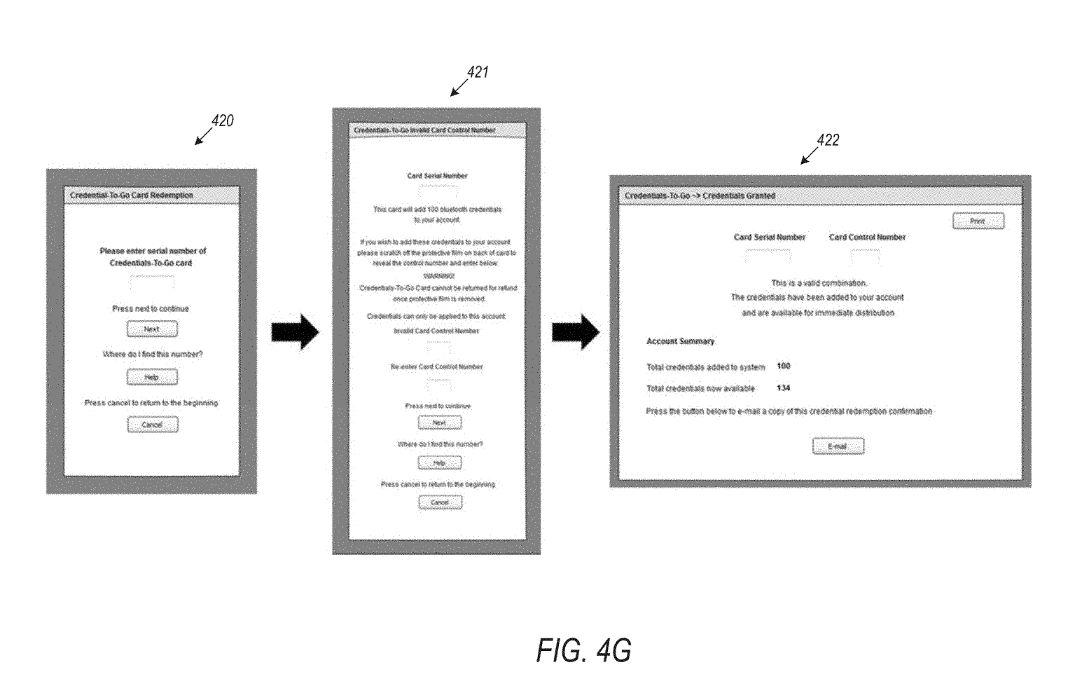

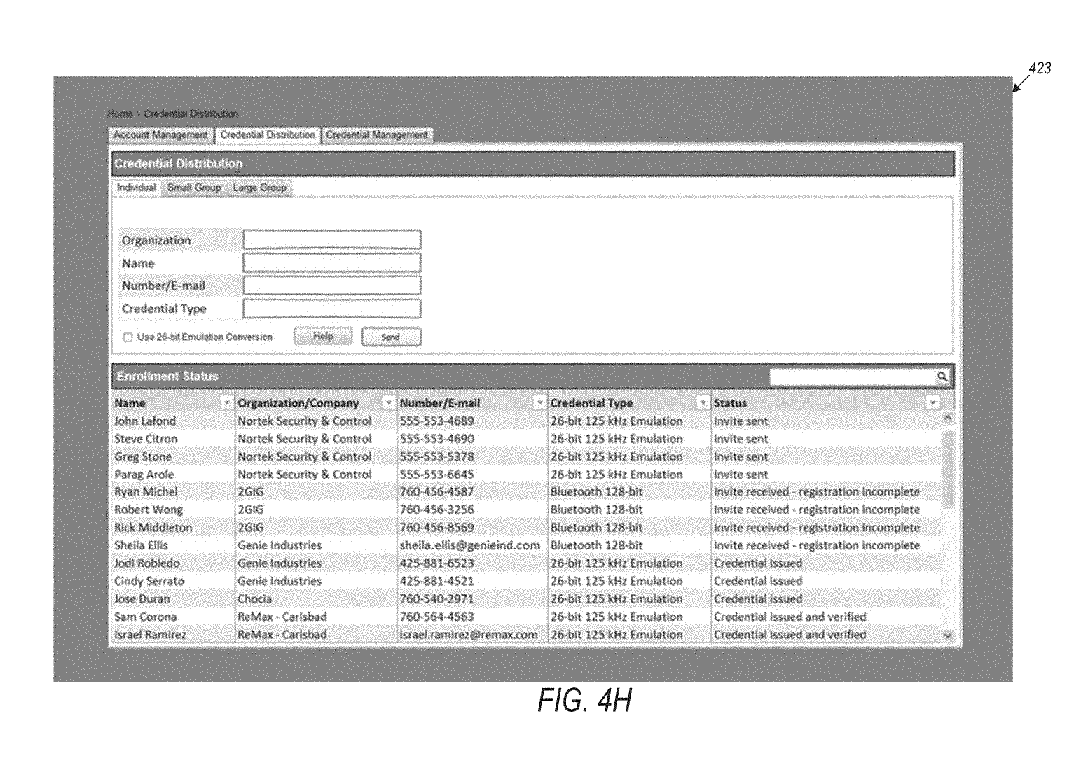

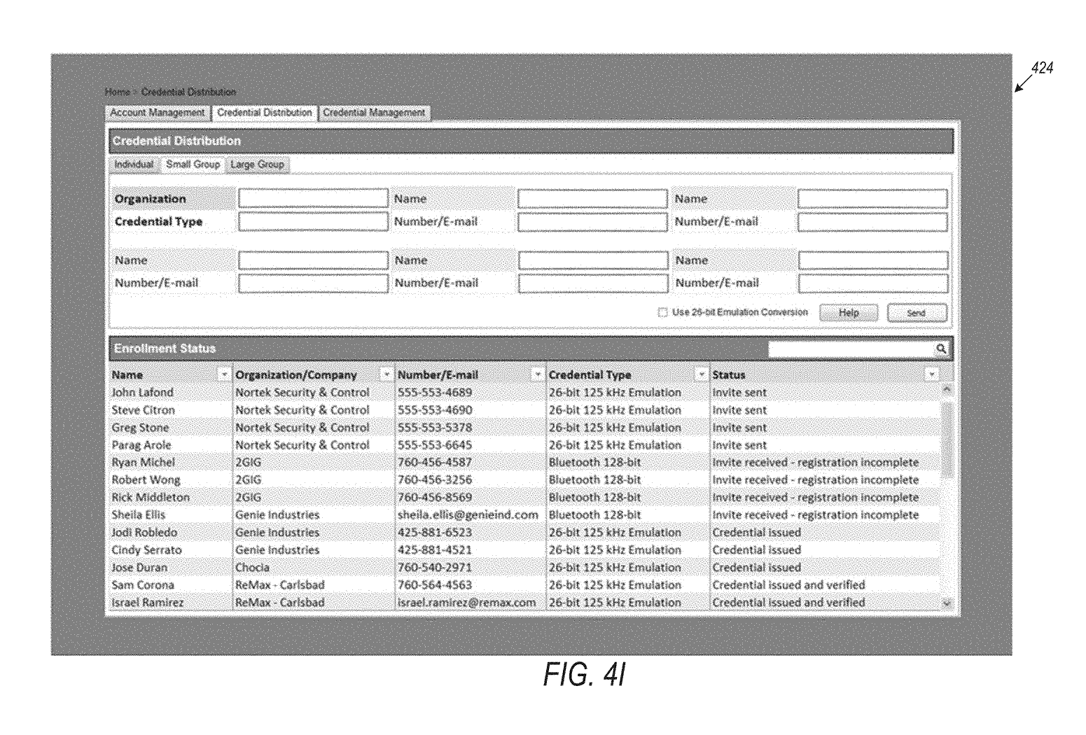

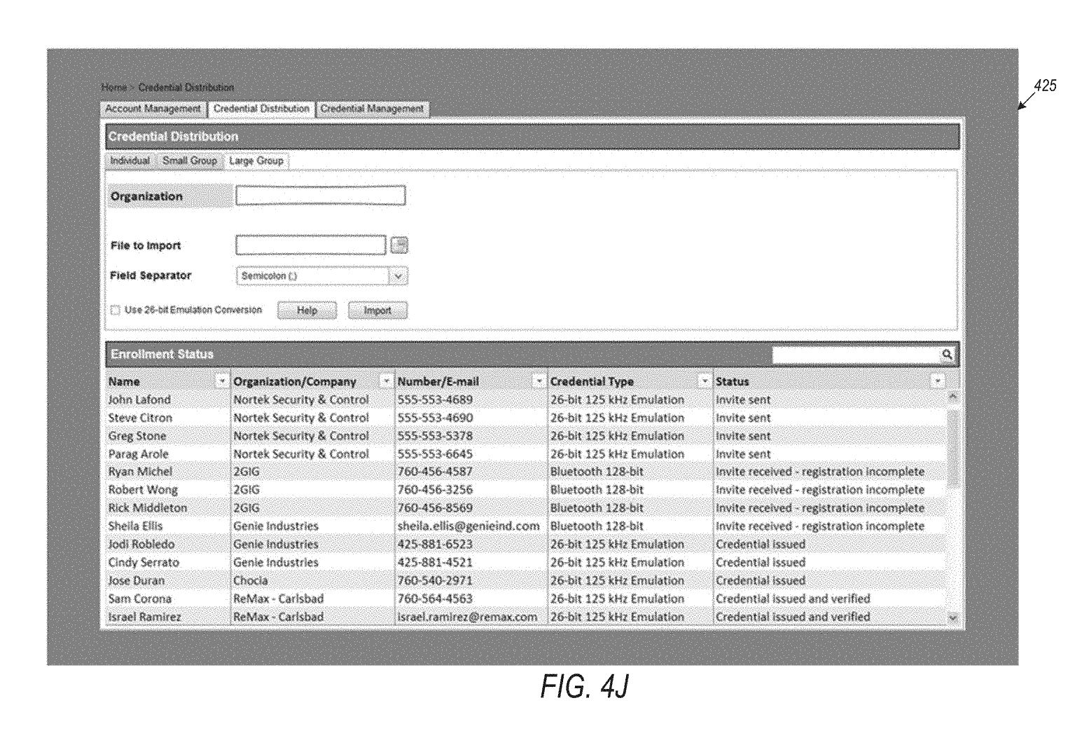

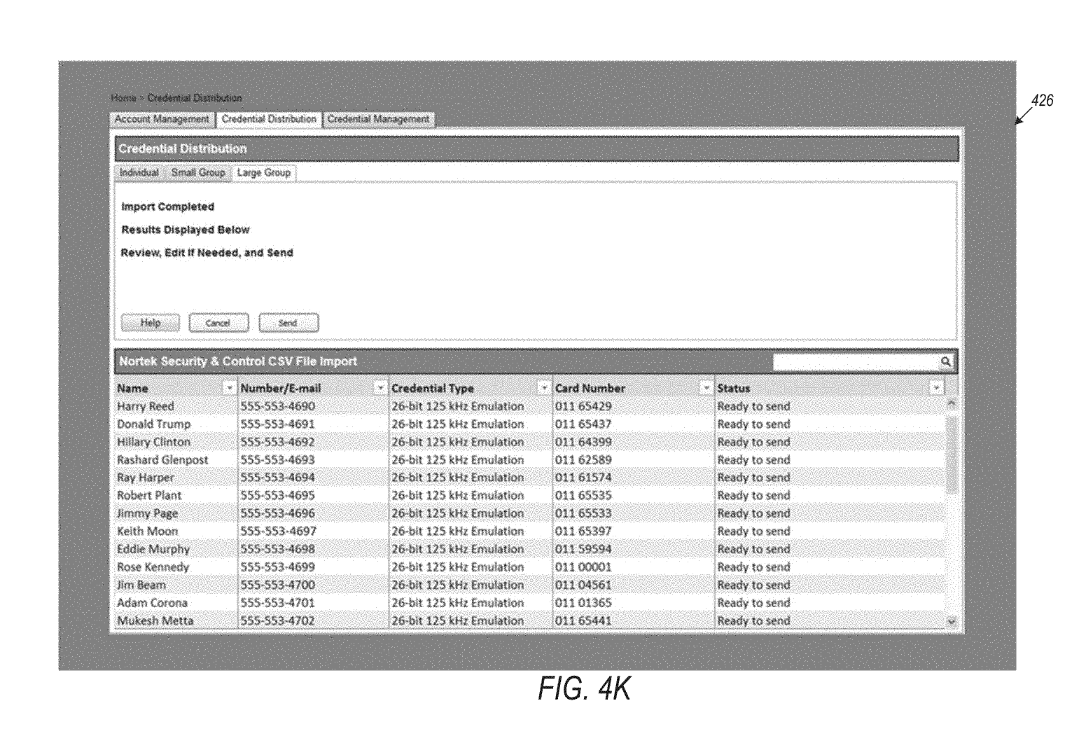

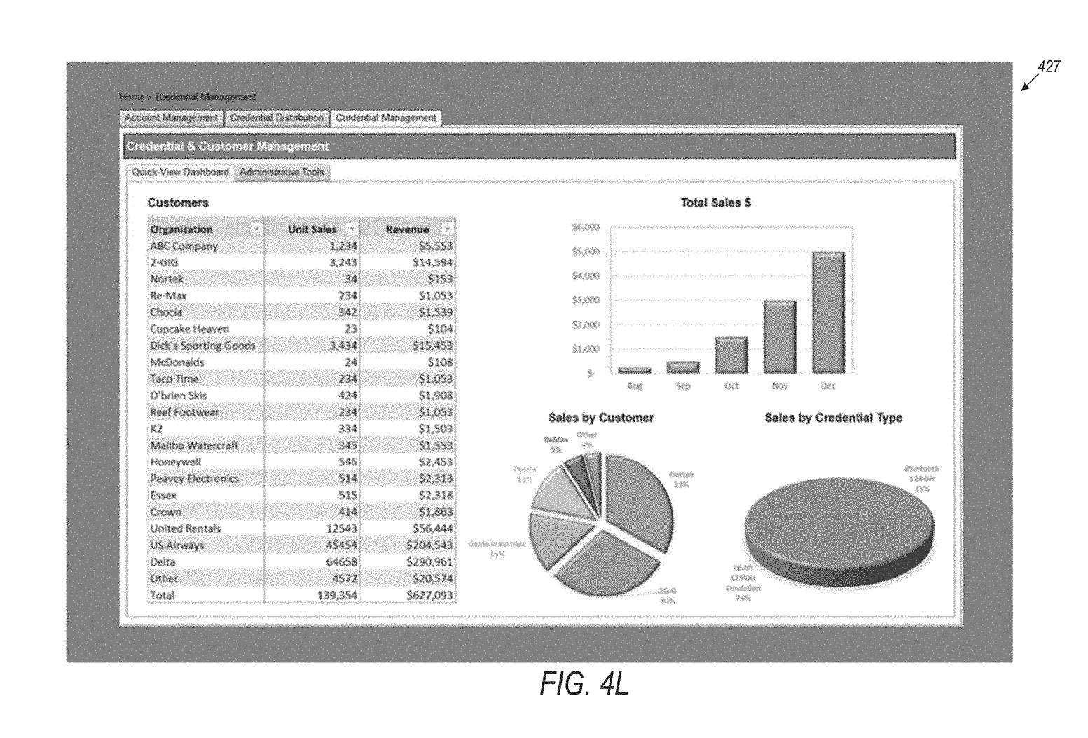

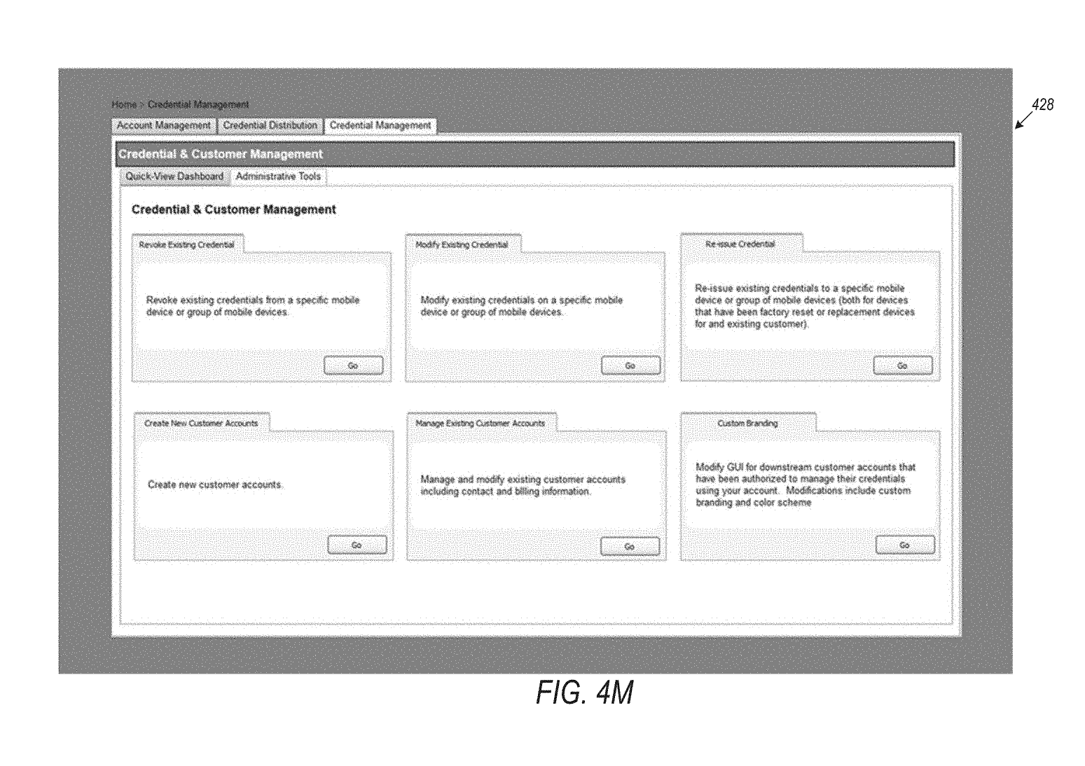

FIG. 3 is a flow diagram illustrating example functionalities for authenticating a credential administrator and issuing credentials using a credential redemption card, in accordance with some embodiments. Referring to FIGS. 1-3, the functionalities 300 may start at 302, when it can be determined whether the administrator 202 is registered with the credential server 206. An example credential server 206 and server components are disclosed in reference to FIG. 4A.

FIG. 4A is a block diagram of an example credential server 206, which can be used in the credential redemption system of FIG. 2, in accordance with an example embodiment. Referring to FIG. 4A, the credential server 206 may comprise suitable circuitry, logic, interfaces and/or code and may be configured to perform functionalities associated with credential credit token card authentication, credential credit redemption, credential generation and communication of credentials to end user devices. For example, the credential server 206 may comprise a storage module 402, a communication module 404, a user authentication module 406, a token authentication module 408, a credential generation module 410, and a user profile management module 412.

The storage module 402 may comprise suitable circuitry, logic, interfaces and/or code and may be configured to store data associated with the administrator profile 207 as well as subscriber data (e.g., database 218). The communication module 404 may comprise suitable circuitry, logic, interfaces and/or code and may be configured to provide wired and/or wireless communication link with the credential administrator and one or more of the subscribers identified by the database 218.

The user authentication module 406 may comprise suitable circuitry, logic, interfaces and/or code and may be configured to authenticate administrators, such as credential administrator 202. For example, the user authentication may be based on the administrator identifier 204 provided by the administrator 202.

The token authentication module 408 may comprise suitable circuitry, logic, interfaces and/or code and may be configured to authenticate credential credit tokens, such as token 100. For example, the token authentication module 408 may use the serial number 104 to generate a control number (or use a look-up table to obtain the control number) corresponding to the entered serial number. The obtained control number may then be compared with the control number 108 received from the administrator 202 to determine whether the token 100 is authentic/valid. Upon authentication, the credential credits associated with the token 100 may be redeemed into the account of the administrator.

The credential generation module 410 may comprise suitable circuitry, logic, interfaces and/or code and may be configured to generate one or more device credentials (e.g., 208) based on credential credits (e.g., 210) available in an account/profile (207) of an administrator (e.g. 202). The credential generation module 410 may also be configured to determine a quantity (e.g., 102) of credential credits associated with a token (e.g., 100). The credential credit quantity may be determined using the serial number 104 and/or the control number 108. Additionally, the credential generation module 410 may further determine a credential type (or types) for the generated credentials.

The user profile management module 412 may comprise suitable circuitry, logic, interfaces and/or code and may be configured to generate and maintain a user profile (e.g., 207) associated with a credential administrator (e.g., 202). For example, the user profile management module 412 may provide one or more graphical user interfaces (GUIs), which may be presented to the credential administrator 202 (e.g., at a mobile device of the administrator) to assist the administrator 202 with redeeming credential credits, generating credentials and communicating such credentials to one or more of the subscribers (or end users) identified by the subscriber database 218.

Referring again to FIG. 3, the credential server 206 (e.g., user authentication module 406) may determine whether the administrator 202 is registered (or has a valid account/profile) based on the administrator identifier 204. At 304, in instances when the administrator is not registered, a profile (or account) 207 may be created by the credential server 206 (e.g., by the user profile management module 412). The profile 207 can include information on available credential credits (e.g., purchased and redeemed by the administrator) as well as credential types associated with the credential credits. At 306, the administrator 202 may further add information on one or more subscribers to the credential provisioning service to create the subscriber database 218. The subscriber database 218 can include information identifying each subscriber (e.g., mobile device number, email address and so forth) as well as information specifying the number and type of device credentials required by each subscriber.

At 308, the credential server 206, may receive the serial number 104 and the control number 108 associated with the portable token 100. At 310, the credential server 206 (e.g., the token authentication module 408) may determine whether the token 100 is authentic (e.g., based on determining a control number from the serial number and matching the determined control number with the control number 108 entered by the administrator 202). If the token is not authenticated, processing may resume at 308 where a new token information may be entered.

Upon authenticating the token 100, processing may resume at 312, where the administrator identifier 204 may also be received. In an example, the administrator identifier 204 may be received together with the serial number 104 and the control number 108, in step 308. At 314, the credential server 206 (e.g., the credential generation module 410) may determine the amount of credential credits (e.g., 102) associated with the token 100, as well as the credential credit type for the credentials that will be generated based on the credits. At 316, the amount of credential credits may be issued (e.g., by the credential generation module 410) to the account/profile (207) of the administrator (202). Additionally, the profile 207 may designate that certain number of credentials (of the determined type) is generated automatically, and then transferred (e.g., at 318) to a subscriber of an access control system (e.g., 216). For example, the credential server 206 may determine that certain subscribers within the database 218 have individual profiles indicating no credentials, or expired credentials that have to be renewed, or have credentials that have to be replaced (e.g., with a different credential type). The credential server 206 may then redeem the issued credential credits, generate the appropriate credentials and automatically communicate the credentials to the corresponding subscribers (e.g., communication of credentials 212.1, . . . , 212.n to corresponding subscriber devices 214.1, . . . , 214.n).

In an example, one or more of the modules 402-412 of the central server 206 may be configured to perform functionalities associated with multi-tiered distribution and management of access control system mobile electronic credentials. Example functionalities include the following: redeeming tokens for credits, each credit representing an access control credential; flexible conversion of such credits, in whole or in part, into a variety of access control credential types/formats when such credential is issued to an end-user's mobile device (such as a smart phone or tablet); manage the software/firmware revisions of the mobile device apps along with the physical hardware that reads/interprets the credential through such apps; update firmware revisions of remotely located reader hardware via a mobile device and storing the geo location, firmware revision number and other information of such installed hardware for ongoing management; assign downstream permissions to end-user administrators to manage their own mobile credentials including the purchasing of such credentials through the upstream entity's credential credits; view credential credit inventory including setting re-order points; view detailed credential sales information both on screen and in report formats; purchasing additional credential credits from supplier directly without the use of physical tokens; issue, re-issue, revoke, suspend, and manage mobile electronic credentials of mobile devices, including tracking status of such activities; integrate directly with access control systems through an API; and perform functions related to administration and end-to-end management of a mobile electronic credential and access control eco-system.

In an example, the credential-management functionalities of the server 206 can include multi-tiered distribution and management, which is not available with conventional mobile credentialing systems. Conventional mobile credentialing systems only offer a one-to-one relationship, whereas the credential issuer has a direct selling relationship to the system end-user administrator with limited accommodation to address the transactional requirements needed for a commercialized, multi-tiered mobile credential distribution system necessary to achieve widespread adoption of mobile credential technology.

In an example, the credential-management functionalities of the server 206 can include distributors' sales of credentials. Credential distribution partners can use functionalities of the server 206 to manage credentials for their downstream customers. In this regard, distributors shall be able to sell electronic credential credits via a physical card as well as through the credential issuance functionalities available from the credential server 206.

In an example, the credential-management functionalities of the server 206 can include dealer/OEM credential purchases. For example, credential direct dealers and OEM's may use functionalities of the server 206 to purchase credentials electronically from upstream suppliers through credential issuance functionalities of the server 206 and through the purchase of physical credential cards (e.g., as seen in FIG. 1), which may be stocked at the distributors' locations.

In an example, the credential-management functionalities of the server 206 can include dealer credential issuance. Dealers can use the functionalities of the server 206 to distribute credentials downstream directly to system end-users via an invitation that is sent to their mobile device. The server 206 may be used to send invitations to an individual user, to a small group of users, or via a CSV-type file (or another type of data file) import to the server 206 with the ability to automate the invitation processing. A CSV-type file can also be exported from the credential server 206 for import to an access control system (e.g., when installing a new system).

In an example, the credential-management functionalities of the server 206 can include management of user roles and delegation of authority. For example, a credentials dealer can assign credential issuance privileges to more sophisticated system end-user administrators, allowing them to purchase credential credits from their upstream dealer's account and also to distribute such credentials directly to their system end-users via the same type of invitation methodology that dealers use when managing this process for less sophisticated customers. In this regard, the server 206 can provide CSV-type file import and export functionalities to an authorized end-user system administrator as well.

In an example, the credential-management functionalities of the server 206 can include mass import function utility. The entity that has authorization to distribute the mobile credentials directly to end-users via mobile device invitation shall have the ability to upload a CSV-type flat file to the credential management/distribution server 206, and then have these invitations sent to the multiple end-users, listed in the flat file, with the touch of just one button (versus hand entering and processing an individual end-user or small group of end-users). This functionality allows for easier distribution of mobile credentials to a large amount of system users.

In an example, the credential-management functionalities of the server 206 can include reporting functionalities. The credential server 206 can he configured to provide basic reporting functionality to assist distributor, dealer, OEM, and administrator of credentials in determining the quantity and type of credentials that have been purchased and/or sold by customer/client for billing and accounting purposes.

In an example, the credential-management functionalities of the server 206 can include supporting emulation conversion. More specifically, the credential management functionalities of server 206 can include a support utility allowing dealers to upload a CSV-type flat file containing a basic list of end-user names, phone numbers, e-mails, and existing credential numbers and automatically transposes such list into invitations that ultimately issues credentials to a group of system end-users that identically matches their respective card/FOB numbers allowing for seamless conversion of the access control system from legacy type credentials to mobile credentials without requiring access system reprogramming.

In an example, the credential-management functionalities of the server 206 can include an intuitive user interface. For example, credential management functions of the server 206 can be used to “serve up” various web pages that provide the user-interface for the system. Such web pages shall consist of common elements, themes, and an intuitive layout but also provide for OEM customer branding and customizable color schemes. In this regard, for each type of user (i.e., distributor, dealer, system administrator, etc.) there can be a set of web pages provided by the server 206. Personnel can navigate to each web page by navigation tabs located at the top of the page. Example user interfaces and pages are illustrated herein in reference to FIGS. 4B-4M. The page tabs can be used to access the following functionalities:

Dealer—Account Information

Displays dealer account information, inventory level, distributor account linkages, purchase options to redeem credential-to-go credits or to simply buy on-line from distributor or dealer directly, etc. Low inventory notifications and an advertorial feature can also be provided to allow for sales promotions, and other enhanced features.

Dealer—Issue Credentials

A user can select “invite single-user” for issuing a mobile credential to an individual user, “invite many users” for a choice between issuing up to 5 users on screen or ability to use CSV-type flat file import for larger invitation quantities. Dealer can choose that the initial invitation is only a link to download app or to simultaneously download the app and issue the credential. Displays various status levels of “open invitations”, such as invited, app downloaded, credential issued, first-time use confirmation. When a system end-user begins the installation process the app installing server software identifies which type of operating system the end-user has and downloads the appropriate app (i.e. iOS app versus android, etc.).

Dealer—Administration/Management

In an example, the server 206 can provide a set of pages for checking status of invitations and to manage credentials that have been issued by company. Credentials can also be suspended or revoked from this section. The server 206 functionalities can also include depicting open credential purchase requests by End-User System Administrators and history of transactions by type and customer and time,

System End-User Administrator—Account Information

In an example, the server 206 can display End-User account information, inventory level, dealer account linkage, purchase options and to add new web-users to the company's account, etc.

System End-User Administrator—Issue Credentials <If Function Enabled by Dealer>

In an example, the server 206 can provide functionality for selecting “invite single-user” for issuing a mobile credential to an individual user, “invite many users” for a choice between issuing up to 5 users on screen or ability to use CSV-type flat file import for larger quantities. The user may choose that the initial invitation is only a link to download app or to simultaneously download the app and issue the credential. The server 206 functionalities may also include displaying various status levels of “open invitations”, such as invited, app downloaded, credential issued, first time use confirmation

System End-User Administrator—Administration/Management

In an example, the server 206 can be configured to provide a set of pages for checking status of invitations and to manage credentials that have been issued by company. Credentials can also be suspended or revoked from this section. The server 206 can also be configured to depict open credential purchase requests by End-User System Administrators.

Multi-User Sign-In Capability

In an example, the server 206 can provide functionalities where super-administration users can create additional sign-in names for their company, and administer each of these user's capabilities (user roles) for access and use of the companies credential management system,

In an example, the credential server 206 can provide one or more application programming interfaces (APIs), including the following:
Single session credential management and assignment: Within a single browser session, system administrators (assuming delegated authority from dealers) and installing dealers can issue credentials directly within the access control interface to simplify/automate the system user enrollment process;
Allow sophisticated dealers who utilize a remote management console to integrate credential issuance and management into the set of web pages for similar convenience and simplicity;
Allow for similar integration into another credential management system to capitalize on selling mobile credentials for Access Control and Security Systems available in the market place; and
Future integration into systems unrelated to Access Control and Security Systems.

In an example, the credential server 206 can be configured to securely communicate directly with one or more of the mobile devices 214.1, . . . , 214.n (and apps running on such devices). Some example communications include:

App-to-Server Communications

An app running on a user device (e.g., 214.1) can communicate to server 206 that it has been successfully installed and provides details about the device it has been installed on (including specific end-user information and other metadata such as unique ID of mobile device, device type, version of operating software for device, geographical location of device at time of app installation, etc.). This functionality allows the server 206 to update the dealer with a status related to each invitation that is sent out to mobile devices and the metadata allows for developer centric product data collection to help improve and optimize the server and app software over time.

The app can also communicate to the server 206 that it has successfully received a credential(s) and server stores such credential information for potential reissue of credential to end-user should the mobile device be replaced in the future. This functionality can allow the server to update the dealer with a status related to each invitation that is sent out to mobile devices. The app can also communicate to the server 206 the successful first time use of the credential.

Server-to-App Communications

The credential server 206 can send the following commands, or otherwise perform the following functions with each discrete App that is installed on a mobile device:
Issue, Suspend, Revoke Credential(s);
Renew a suspended or revoked Credential(s);
Create a time schedule for a credential(s);
Edit a time schedule for a credential(s);
Delete a time schedule for a credential(s); and
Update of Linear reader firmware.

The server 206 can also be configured to update firmware for secure credential readers (e.g., at system 216), such as Linear Bluetooth readers in the field via the app when the mobile device is in “Administration mode”. The server 206 can use the mobile device's Internet connection combined with a credential management app to update firmware on a Linear Bluetooth reader, using the mobile device as a bridge to connect the server's 206 Reader Update Utility (e.g., a separate software module) directly to the reader. In some applications where Internet connectivity is limited, the App can actually store the firmware update in the app and allow the reader to be updating with such firmware independent of an active Internet connection.

FIG. 4B-FIG. 4M illustrate various functionalities (including functionalities discussed herein above), which can be performed by the credential server of FIG. 4A, in accordance with some embodiments. FIG. 4B illustrates user interfaces 413-414, which can be used for a sign-in to access functionalities provided by server 206, or to create a new user profile. FIG. 4C illustrates user interfaces 415-416, which can be used for user name and password recovery. FIG. 4D illustrates a user interface 417 for accessing a quick-view dashboard associated with account management functions provided by the server 206. FIG. 4E illustrates a user interface 418 for accessing a web-user management interface associated with account management functions provided by the server 206. FIG. 4F illustrates a user interface 419 for accessing an administrative tools interface associated with account management functions provided by the server 206.

FIG. 4G illustrates user interfaces 420-422, which can be used to redeem credentials using a portable token or card (e.g., 100 in FIG. 1). FIG. 4H illustrates a user interface 423 for accessing an individual credential distribution interface associated with credential distribution functions provided by the server 206. FIG. 41 illustrates a user interface 424 for accessing a small group credential distribution interface associated with credential distribution functions provided by the server 206. FIG. 4J illustrates a user interface 425 for accessing a large group credential distribution interface associated with credential distribution functions provided by the server 206. FIG. 4K illustrates a user interface 426 for accessing a large group credential distribution interface associated with credential distribution functions provided by the server 206, after a successful import of a CSV file with user data used for automatic credential distribution. FIG. 4L illustrates a user interface 427 for accessing a quick-view dashboard interface associated with credential management functions provided by the server 206. FIG. 4M illustrates a user interface 428 for accessing an administrative tools interface associated with credential management functions provided by the server 206.

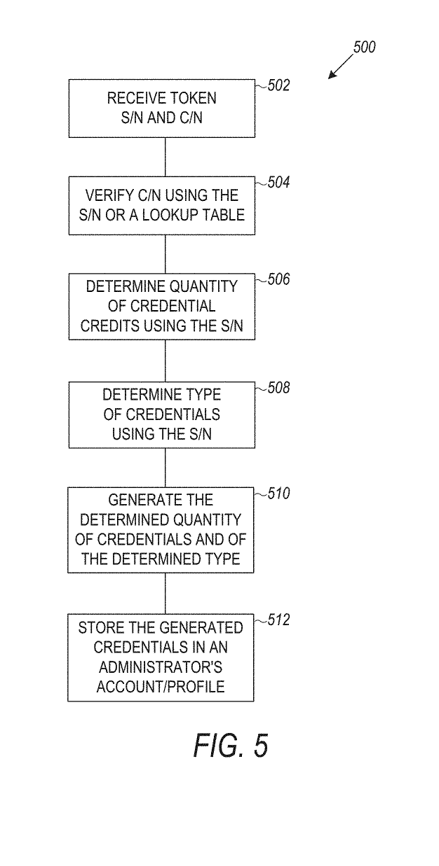

FIG. 5 is a flow diagram illustrating example functionalities for issuing credentials of a specified type using a credential redemption card, in accordance with some embodiments. Referring to FIG. 5, the functionalities 500 may be performed by one or more modules of the credential server 206. At 502, at least two token identifiers may be received. For example, the credential administrator may use a computing device (e.g., mobile device) to communicate the serial number 104 and the control number 108 associated with the portable token 100. In an example, the serial number 104 can be visible on the token (which can be a plastic card) and the control number 108 can be revealed after removing a tamper-revealing coating/film. In other examples, both the serial number and the control number can be represented via a bar-code (or another type of device-readable medium), and the administrator 202 may use its computing device to scan both bar codes and automatically transmit those to the credential server 206. Additionally, the third identifier (e.g., administrator identifier 204) may also be transmitted with the control and serial numbers, for purposes of administrator authentication by the credential server 206.

At 504, the control number 108 may be verified based on the serial number 104. For example, a valid control number may be encoded within the serial number 104. The token authentication module 408 may then decode the serial number 104 to obtain the valid control number. If the valid control number matches the control number 108 received from the administrator 202, then the token 100 is authenticated. If there is no match, then a notification of invalid token may be sent to the administrator 202.

At 506, the quantity of credential credits associated with the token 100 may be determined. For example, the quantity of credential credits may be encoded within the serial number 104, or a combination of the serial number 104 and the control number 108. At 508, the type of credentials may be determined, associated with credentials that can be issued using the credential credits. For example, the credential type (similar to the quantity of credential credits) may be encoded within the serial number 104, or a combination of the serial number 104 and the control number 108.

At 510, the quantity of credentials of the determined type may be generated (e.g., by the credential generation module 410). In an example, the credential credits may be issued to the account of the administrator 202, and then the credential credits may be redeemed for credentials (of the determined type), which may be stored in the administrator account (e.g., at 512) or communicated to end users (subscribers or customers of the credential provisioning service of the administrator).

In an example, after step 506, the determined quantity of credentials may be stored in the administrator's account (i.e., at 512) as a balance of available generic credits, without determining a credential type. Subsequently (e.g., at 510), the generic credits can be redeemed (at a different rate) for one or more types of credentials. In an example, the plurality of credential credits associated with a token may be generic credential credits, which may be redeemed (e.g., at a later time) at a different rate for a different type of credential. For example, a temporary electronic credential may be generated/issued for (i.e., may “cost”) 2 credential credits, a one-time credential may be issued for 0.75 credential credits, a permanent credential may be issued for 10 credential credits, and so forth.

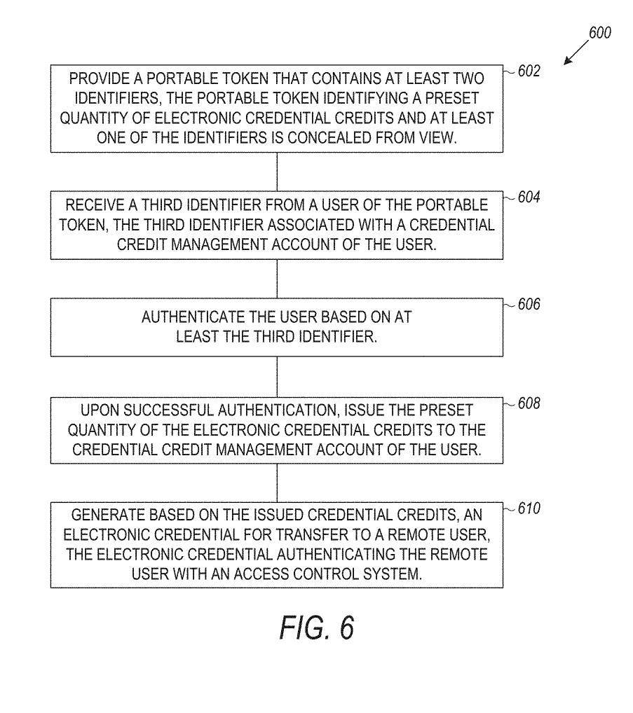

FIG. 6 is a flow diagram illustrating example functionalities for automatically issuing credentials to a remote user from a credential administrator account using a credential redemption card, in accordance with some embodiments. Referring to FIG. 6, the example method 600 may start at 602, when a portable token (e.g., 100) that contains at least two identifiers may be provided. The portable token may identify a preset quantity of electronic credential credits and at least one of the identifiers is concealed from view. For example, the portable token 100 may identify the quantity of credential credits 102. Additionally, the control number 108 may be concealed from view via a tamper-revealing coating 110. At 604, a third identifier may be received from a user of the portable token. The third identifier may be associated with a credential credit management account of the user. For example, the credential server 206 may receive the administrator identifier 204, which may be used to grant the administrator 202 access to the profile 207. At 606, the user may be authenticated based on at least the third identifier. For example, the administrator 202 may be authenticated based on the identifier 204. At 608, upon successful authentication, the preset quantity of the electronic credential credits may be issued to the credential credit management account of the user. For example, credential credits 210 may be issued to the administrator account 207. At 610, an electronic credential may be generated based on the issued credential credits. For example, the credentials 208 (which are also indicated as 212.1, . . . , 212.n) may be generated based on the credential credits 210. The electronic credential (e.g., 212.1) may be transferred to a remote user (e.g., credential is communicated to user device 214.1) and may be used to authenticate the remote user with an access control system (e.g., 216).

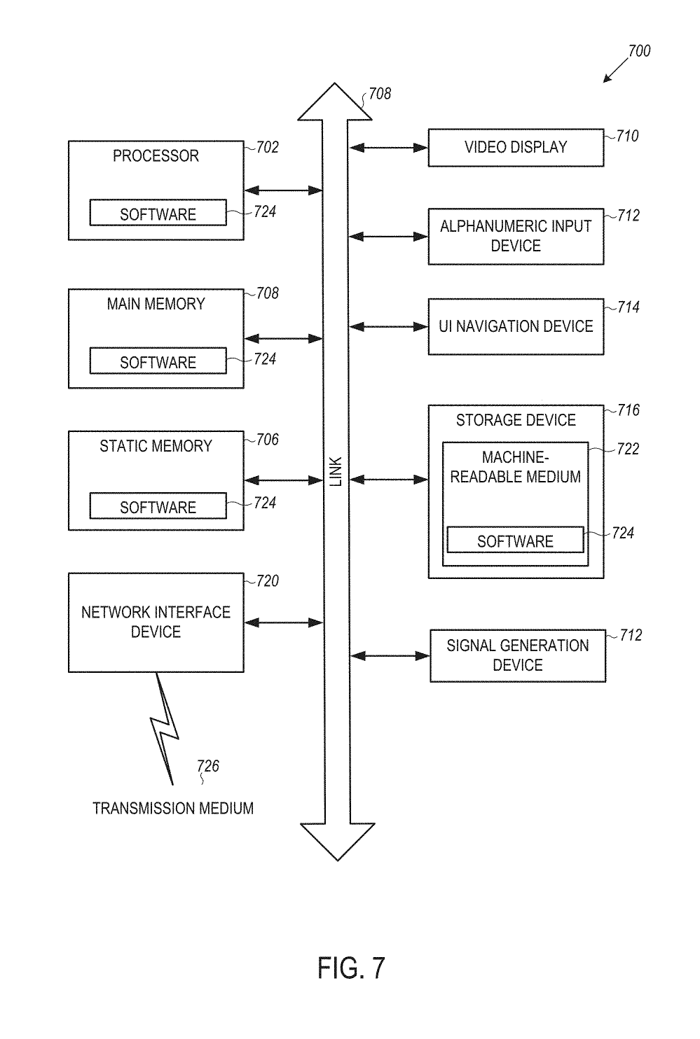

FIG. 7 illustrates a block diagram of a communication device, in accordance with some embodiments. In alternative embodiments, the communication device 700 may operate as a standalone device or may be connected (e.g., networked) to other communication devices. In a networked deployment, the communication device 700 may operate in the capacity of a server communication device (e.g., as a credential server 206), a client communication device (e.g., one or more of the remote user devices 214.1, . . . , 214.n or a mobile device used by the administrator 202 to access the credential server 206), or both in server-client network environments. In an example, the communication device 700 may act as a peer communication device in peer-to-peer (P2P) (or other distributed) network environment. The communication device 700 may be a PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., mobile device or server) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The communication device 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The communication device 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The communication device 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a communication device readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the communication device 700. In an example, one or any combination of the hardware processor 702, the main memory 704, the static memory 706, or the storage device 716 may constitute communication device readable media.

While the communication device readable medium 722 is illustrated as a single medium, the term “communication device readable medium” may include a single medium or multiple media (e.g., a centralized or distributed database, and/or associated caches and servers) configured to store the one or more instructions 724.

The term “communication device readable medium” may include any medium that is capable of storing, encoding, or carrying instructions for execution by the communication device 700 and that cause the communication device 700 to perform any one or more of the techniques of the present disclosure, or that is capable of storing, encoding or carrying data structures used by or associated with such instructions. Non-limiting communication device readable medium examples may include solid-state memories, and optical and magnetic media. Specific examples of communication device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device readable media may include non-transitory communication device readable media. In some examples, communication device readable media may include communication device readable media that is not a transitory propagating signal.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), MIMO, or multiple-input single-output (MISO) techniques. In some examples, the network interface device 720 may wirelessly communicate using Multiple User MIMO techniques. The term “transmission medium” shall be taken to include any intangible medium that is capable of storing, encoding or carrying instructions for execution by the communication device 700, and includes digital or analog communications signals or other intangible medium to facilitate communication of such software.

### ADDITIONAL NOTES AND EXAMPLES

Example 1 is a method, comprising: providing a portable token that contains at least two identifiers, wherein the portable token identifies a preset quantity of electronic credential credits and at least one of the identifiers is concealed from view; receiving a third identifier from a user of the portable token, the third identifier associated with a credential credit management account of the user; authenticating the user based on at least the third identifier; upon successful authentication, issuing the preset quantity of the electronic credential credits to the credential credit management account of the user and generating based on the issued credential credits, an electronic credential for communication to a remote user, the electronic credential authenticating the remote user with an access control system.

In Example 2, the subject matter of Example 1 optionally includes wherein the portable token is a card that contains a serial number as one of the at least two identifiers, and a control number as another identifier of the at least two identifiers.

In Example 3, the subject matter of Example 2 optionally includes wherein the serial number is visible through the packaging and the control number is concealed.

In Example 4, the subject matter of Example 3 optionally includes wherein the control number is covered by a tamper-revealing film that can be scratched off in order to reveal the control number.

In Example 5, the subject matter of any one or more of Examples 2-4 optionally include wherein the authenticating further comprises: verifying the control number based on an algorithm indexed off of the serial number.

In Example 6, the subject matter of any one or more of Examples 2-5 optionally include wherein the control number is a random set of numbers and/or characters, and the authenticating further comprises: verifying the control number using a cross-reference table linking the serial number with the control number.

In Example 7, the subject matter of any one or more of Examples 2-6 optionally include deriving the preset quantity of electronic credential credits from the serial number.

In Example 8, the subject matter of any one or more of Examples 2-7 optionally include issuing a plurality of credentials to the credential credit management account of the user based on the preset quantity of electronic credential credits.

In Example 9, the subject matter of Example 8 optionally includes determining from the serial number, a credential type associated with the plurality of credentials, wherein the credential type is one of a temporary electronic credential, a one-time electronic credential or a permanent electronic credential.

In Example 10, the subject matter of Example 9 optionally includes a 26-bit credential, a 37-bit credential, a 128-bit credential or a 256-bit credential. Other credential types may also be used, such as 96-bit, 200-bit, as well as other types with a different bit strength.

In Example 11, the subject matter of any one or more of Examples 9-10 optionally include wherein a number of the issued plurality of credentials is based on the credential type.

In Example 12, the subject matter of any one or more of Examples 8-11 optionally include acquiring a list of subscribers to an access control system, the list of subscribers associated with the credential credit management account of the user; and automatically communicating at least one of the plurality of credentials to a corresponding one of the subscribers, the communicated at least one credential for obtaining authorization to the access control system via a communication device of the corresponding subscriber.

In Example 13, the subject matter of any one or more of Examples 1-12 optionally include wherein the third identifier is one of the following: an account number of the credential credit management account of the user; and a user name or password used by the user to access the credential credit management account or, for higher security purposes, another identifying number, unbeknownst to the administrator, that is contained in a reference look-up table that is associated with the account number or user name and password.

Example 14 is a portable token for obtaining a plurality of electronic credentials, the token comprising: a first identifier that is visible on the token; and a second identifier that is concealed from view by a temporary cover on at least a portion of the token, wherein: the first identifier allows for determining a quantity of the plurality of electronic credentials; and the first identifier and the control identifier allow a user to obtain access to the determined quantity of electronic credentials upon entering a third identifier, the third identifier associated with an account of the user.

In Example 15, the subject matter of Example 14 optionally includes wherein the first identifier is a serial number and the second identifier is a control number that is covered by a tamper-revealing film,

In Example 16, the subject matter of any one or more of Examples 14-15 optionally include wherein the first identifier further allows for determining a credential type associated with the plurality of electronic credentials.

Example 17 is a system, comprising: a memory; and a processor coupled to the memory, the processor configured to: detect using a portable token, a first identifier and a second identifier; detect a third identifier of a user of the portable token; derive a quantity of electronic credential credits using the first identifier; authenticate the user based on the first, second and third identifiers; and upon successful authentication, issue the quantity of electronic credential credits to a credential credit management account of the user.

In Example 18, the subject matter of Example 17 optionally includes wherein the first identifier is a serial number and the second identifier is a control number, the serial number and the control number being printed on the portable token.

In Example 19, the subject matter of Example 18 optionally includes wherein the processor is further configured to: generate within the credential credit management account of the user, a plurality of electronic credentials based on the preset quantity of electronic credential credits.

In Example 20, the subject matter of Example 19 optionally includes wherein the plurality of electronic credentials comprises at least one electronic key for obtaining authorization to an access control system.

In Example 21, the subject matter of Example 20 optionally includes wherein the processor is further configured to: determine using the serial number, a credential type associated with the plurality of credentials, wherein the credential type is one of a temporary electronic credential, a schedule-associated credential, a one-time electronic credential, a permanent electronic credential, or a standard electronic credential. In an example, the plurality of credential credits associated with a token may be generic credential credits, which may be redeemed (e.g., at a later time) at a different rate for a different type of credential. For example, a temporary electronic credential may be generated/issued for (i.e., may “cost”) 2 credential credits, a one-time credential may be issued for 0.75 credential credits, a permanent credential may be issued for 10 credential credits, and so forth.

In Example 22, the subject matter of any one or more of Examples 20-21 optionally include wherein the processor is further configured to: access using the third identifier, a list of subscribers to an access control system, the list of subscribers associated with the credential credit management account of the user.

In Example 23, the subject matter of Example 22 optionally includes wherein the processor is further configured to: communicate at least one of the plurality of credentials to a corresponding one of the subscribers, the communicated at least one credential for obtaining authorization to the access control system via a communication device of the corresponding subscriber.

Example 24 is a computer-readable storage medium that stores instructions for execution by one or more processors of a computing device, the one or more processors to configure the device to: detect using a portable token, a first identifier and a second identifier; receive a third identifier of a user of the portable token, the third identifier for accessing a credential management account of the user; derive a quantity of electronic credential credits using the first identifier; authenticate the user based on the first, second and third identifiers; and upon successful authentication, issue the quantity of electronic credential credits to the credential management account of the user.

In Example 25, the subject matter of Example 24 optionally includes wherein the one or more processors further configure the device to: generate a plurality of credentials corresponding to the credential credits; and communicate a credential of the plurality of credentials to a remote device for authorizing the device to access a credential-based control system using the credential.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated, in the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method, comprising:
providing a portable token that contains at least two identifiers, wherein the portable token identifies a preset quantity of electronic credential credits and at least one of the identifiers is concealed from view,
receiving a third identifier from a user of the portable token, the third identifier associated with a credential credit management account of the user;
authenticating the user based on at least the third identifier;
upon successful authentication, issuing the preset quantity of the electronic credential credits to the credential credit management account of the user; and
generating based on the issued credential credits, an electronic credential for communication to a remote user, the electronic credential authenticating the remote user with an access control system.

2. The method according to claim 1, wherein the portable token is a card that contains a serial number as one of the at least two identifiers, and a control number as another identifier of the at least two identifiers.

3. The method according to claim 2, wherein the serial number is visible through the packaging and the control number is concealed.

4. The method according to claim 3, wherein the control number is covered by a tamper-revealing film that can be scratched off in order to reveal the control number.

5. The method according to claim 2, wherein the authenticating further comprises:
verifying the control number based on an algorithm indexed off of the serial number.

6. The method according to claim 2, wherein the control number is a random set of numbers and/or characters, and the authenticating further comprises:
verifying the control number using a cross-reference table linking the serial number with the control number.

7. The method according to claim 2, further comprising:
deriving the preset quantity of electronic credential credits from the serial number.

8. The method according to claim 2, further comprising:
issuing a plurality of credentials to the credential credit management account of the user based on the preset quantity of electronic credential credits.

9. The method according to claim 8, further comprising:
determining from the serial number, a credential type associated with the plurality of credentials, wherein the credential type is one of a temporary electronic credential, a one-time electronic credential or a permanent electronic credential.

10. The method according to claim 9, wherein the credential type is one of a 26-bit credential, a 37-bit credential, a 96-bit credential, a 128-bit credential, a 200-bit credential, or a 256-bit credential.

11. The method according to claim 9, wherein a number of the issued plurality of credentials is based on the credential type.

12. The method according to claim 8, further comprising:
acquiring a list of subscribers to an access control system, the list of subscribers associated with the credential credit management account of the user; and
automatically communicating at least one of the plurality of credentials to a corresponding one of the subscribers, the communicated at least one credential for obtaining authorization to the access control system via a communication device of the corresponding subscriber.

13. The method according to claim.1, wherein the third identifier is one of the following:
an account number of the credential credit management account of the user; and
a user name or password used by the user to access the credential credit management account.

14. A portable token for obtaining a plurality of electronic credentials, the token comprising:
a first identifier that is visible on the token; and
a second identifier that is concealed from view by a temporary cover on at least a portion of the token, wherein:
the first identifier allows for determining a quantity of the plurality of electronic credentials; and
the first identifier and the control identifier allow a user to obtain access to the determined quantity of electronic credentials upon entering a third identifier, the third identifier associated with an account of the user.

15. The portable token of claim 14, wherein the first identifier is a serial number and the second identifier is a control number that is covered by a tamper-revealing film.

16. The portable token of claim 14, wherein the first identifier further allows for determining a credential type associated with the plurality of electronic credentials.

17. A system, comprising:
a memory; and
a processor coupled to the memory, the processor configured to:
detect using a portable token, a first identifier and a second identifier;
detect a third identifier of a user of the portable token;
derive a quantity of electronic credential credits using the first identifier;
authenticate the user based on the first, second and third identifiers; and
upon successful authentication, issue the quantity of electronic credential credits to a credential credit management account of the user.

18. The system according to claim 17, wherein the first identifier is a serial number and the second identifier is a control number, the serial number and the control number being printed on the portable token.

19. The system according to claim 18, wherein the processor is further configured to:
generate within the credential credit management account of the user, a plurality of electronic credentials based on the preset quantity of electronic credential credits.

20. The system according to claim 19, wherein the plurality of electronic credentials comprises at least one electronic key for obtaining authorization to an access control system.

21. The system according to claim 20, wherein the processor is further configured to:
determine using the serial number, a credential type associated with the plurality of credentials, wherein the credential type is one of a temporary electronic credential, a schedule-associated credential, a one-time electronic credential, a permanent electronic credential, or a standard electronic credential.

22. The system according to claim 20, wherein the processor is further configured to:
access using the third identifier, a list of subscribers to an access control system, the list of subscribers associated with the credential credit management account of the user.

23. The system according to claim 22, wherein the processor is further configured to:
communicate at least one of the plurality of credentials to a corresponding one of the subscribers, the communicated at least one credential for obtaining authorization to the access control system via a communication device of the corresponding subscriber.

24. A computer-readable storage medium that stores instructions for execution by one or more processors of a computing device, the one or more processors to configure the device to:
detect using a portable token, a first identifier and a second identifier;
receive a third identifier of a user of the portable token, the third identifier for accessing a credential management account of the user;
derive a quantity of electronic credential credits using the first identifier,
authenticate the user based on the first, second and third identifiers; and
upon successful authentication, issue the quantity of electronic credential credits to the credential management account of the user.

25. The computer-readable storage medium according to claim 24, wherein the one or more processors further configure the device to:
generate a plurality of credentials corresponding to the credential credits; and
communicate a credential of the plurality of credentials to a remote device for authorizing the device to access a credential-based control system using the credential.
